(19) United States
(12) Patent Application Publication
(10) Pub. No.: US 2014/0230332 A1
(43) Pub. Date: Aug. 21, 2014

(54) DOOR WITH HANDLE

(71) Applicant: FAMAR MUEBLES, S.L., Albacete (ES)

(72) Inventors: Fabian Martinez Garcia, Albacete (ES); Francisco Martinez Garcia, Albacete (ES)

(21) Appl. No.: 14/353,150

(22) PCT Filed: Oct. 23, 2012
(86) PCT No.: PCT/ES2012/070737

§ 371 Date: Apr. 21, 2014

(30) Foreign Application Priority Data
Oct. 24, 2011 (ES) P201131703

(51) Int. Cl. E05B 1/00

(52) U.S. Cl. CPC E05B 1/0015; E05B 2001/0023
USPC 49/353

(57) ABSTRACT

Furniture door with handle, comprising a panel (2) on one of the edges of which (7) a profile (3) comprising the handle is fixed to said edge by clipping and by way of an auxiliary piece (4).

### FIELD OF THE INVENTION

The present invention relates to a door with a handle, in particular a furniture door, comprising a generally rectangular contour panel, which has a profile comprising the handle mounted on one of its edges.

The doors with the described configuration are in particular used in kitchen furniture, but may also be used in other types of furniture, such as wardrobe and bookcase doors, drawers, etc., the profile, in the case of the doors, being situated on one of the free edges of the door.

### BACKGROUND OF THE INVENTION

In the doors of the type indicated, the fixing of the profile to the edge of the door is usually carried out, in general, through three different systems: by means of adhering with a contact adhesive or assembly glue, by means of screws or by means of a longitudinally barbed dowel which protrudes from the support base of the profile over the edge of the door and is intended to be introduced at pressure into a channel running along the edge of said door.

In order to ensure the fixing by means of adhesion, the profile comprising the handgrip has a wing which is attached to a rear surface of the door, to which it is fixed by means of contact adhesive. This system requires that the profile be positioned with precision from the start since these types of adhesive do not allow the position to be rectified. The use of assembly glues is also known which allow the position of the pieces to be corrected, but require the use of jacks which pressure the elements into joining until the adhesive has completely hardened.

Fixing by means of screws is carried out by way of a wing of the profile which is attached on the rear surface of the door. The screws are visible when opening the door, producing the resulting unsightly effect. Such fixing may also be completed with fixing by means of assembly glue, between the wing mentioned and the door.

Lastly, fixing by means of a longitudinally barbed dowel of the profile and groove of the edge of the door, involves a more expensive system since the profile must be fitted with the dowel mentioned and at the edge of the door, the groove must be carried out by means of the corresponding operation. This system may also be completed by applying the assembly glue between the dowel and walls of the groove.

### DESCRIPTION OF THE INVENTION

The object of the present invention is a door of the type presented in the introduction, in which the fixing of the profile comprising the handgrip to the edge of the door is carried out by means of clipping, fixing which may also be completed using adhesive or glue.

For this purpose, in accordance with the invention, auxiliary anchoring pieces consisting of plates with a width less than the edge of the door are fixed on the edge of the door on which the profile comprising the handgrip is situated. Said plates and the profile have opposing configurations, coupleable by pressure, which define the clipping means.

The plates mentioned may have at least one through opening for passing fixing screws to the edge of the door.

Along the edge of the door, there is a series of auxiliary fixing pieces, all of which must be correctly positioned on the edge of the door so that fixing of the profile may be carried out by clipping and also so that said profile may be correctly positioned.

In order to ensure the positioning of the auxiliary anchoring pieces, in accordance with the invention, said pieces have positioning means which consist of a partition protruding from one of the laterals of said piece parallel to the surfaces of the door, in a direction perpendicular to the support surface of the auxiliary anchoring piece on the edge of the door. This partition is intended to be attached on one of the lateral surfaces of the door, serving as a support and reference means which defines the correct position of the auxiliary piece on the edge of the door.

According to a variant embodiment, the auxiliary pieces may consist of a plate from the lower surface of which protrudes a barbed projection which is introduced in an adjusted form into the mechanized housing on the edge of the door. This barbed projection serves, together with the housing of the edge of the door, as a means for fixing the plate to the door and as positioning means of said plate.

The configurations of the auxiliary anchoring pieces which define the clipping means may be comprised of the two opposing edges parallel to the surfaces of the door, the edges of which have inclines which converge towards the support base on the edge of the door. In turn, the profile has, on the support surface on the edge of the door, a central longitudinal hollow with width coinciding with that of the auxiliary anchoring pieces. This hollow is longitudinally limited by edges which have inclines opposing those of the opposing edges of the auxiliary pieces so as to be coupleable on the same by means of pressure.

The configurations of the auxiliary anchoring pieces which define the clipping means may also comprise flaps which protrude, in matching number and position, from said piece and from the opposing surface of the profile, the flaps of the auxiliary pieces and of the profile having opposing inclines for their coupling by pressure.

In any of the cases, the profile may also have, starting from the rear longitudinal edge, a wing perpendicular to the support surface on the edge of the door, the wing of which is intended to be attached and fixed by means of an adhesive on the rear surface of the door.

Once the auxiliary anchoring pieces have been mounted on the edge of the door and prior to mounting the profile, which would comprise the handgrip, the cutting of the partition takes place, which partition comprises the positioning means of these auxiliary pieces such that the latter have a total width equal to that of the central longitudinal hollow below the profile.

The plate comprising the auxiliary anchoring pieces may be of plastic material or of metallic nature. In any case, these pieces may have a line of weakness which facilitates separation of the partition comprising the positioning means of the auxiliary pieces.

### BRIEF DESCRIPTION OF THE DRAWINGS

In the attached drawings, a non-limiting exemplary embodiment of a door comprised in accordance with the invention:

FIG. 1 being a transverse section of a door with a handle, comprised in accordance with the invention.

FIG. 2 being a similar view as FIG. 1, with the profile comprising the handle in an initial mounting position on the door.

FIG. 3 is a partial perspective view of a door, on the upper edge of which are fixed the upper pieces on which the profile comprising the handlegrip are mounted by means of clipping.

FIG. 4 is a top perspective view of the anchoring piece included in FIG. 3.

FIG. 5 is a bottom perspective view of the same auxiliary anchoring piece.

FIG. 6 is a transverse section of the anchoring piece, taken according to the VI-VI cut line of FIG. 4.

FIG. 7 is a similar view as FIG. 4, showing a variant embodiment of the auxiliary anchoring plate.

FIG. 8 is a side elevation of the anchoring plate of FIG. 7.

FIGS. 9 and 10 are similar views to FIG. 3, showing further variant embodiments.

### DETAILED DESCRIPTION OF A FORM OF EMBODIMENT

The characteristics and advantages of the door according to the invention may be better understood from the following description, with reference made to the exemplary embodiment shown in the attached drawings.

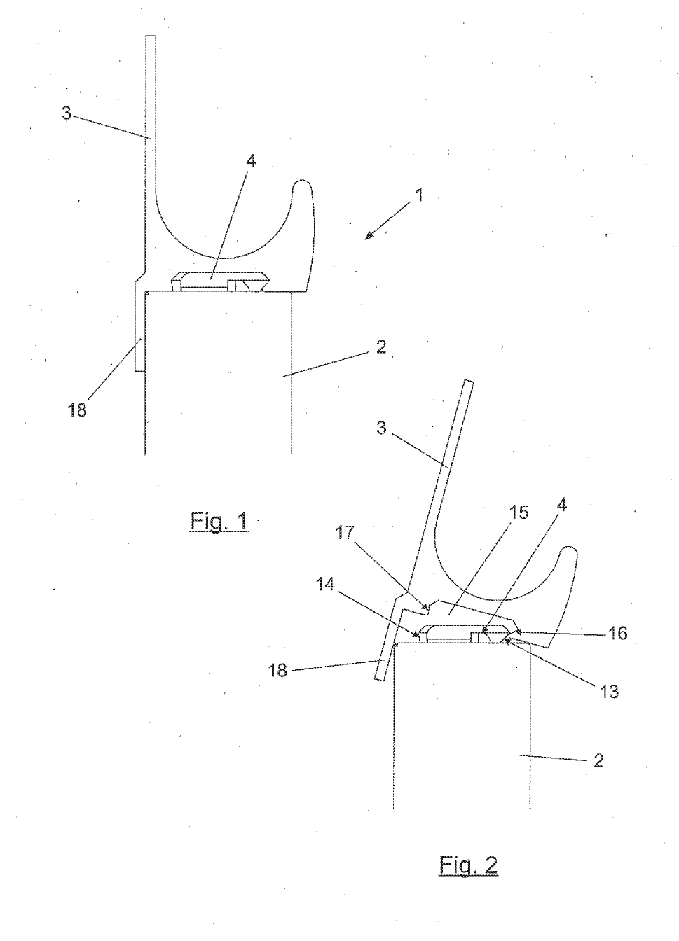

In FIG. 1 is shown a partial vertical section of a door 1 comprising a panel 2 on the upper edge of which is fixed a profile 3 comprising the handgrip of the door 1. The fixing of the profile 3 on the panel 2 is carried out by clipping on auxiliary anchoring pieces 4 previously fixed on the edge of the panel 2.

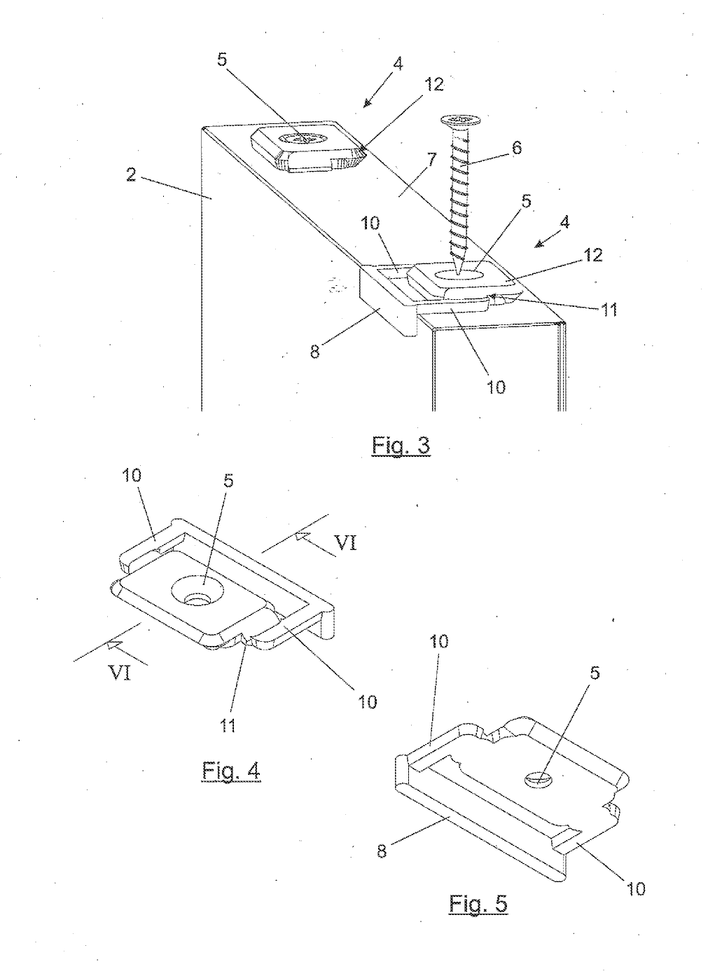

The anchoring pieces 4, as may be seen more clearly in FIGS. 4 to 6, consist of a plate which has an intermediate through opening 5 for passing a fixing screw 6 to the panel 2, as shown in FIG. 3. The plate mentioned also has positioning means on the edge 7 of 2, with the aim of ensuring that all the auxiliary pieces 4 fixed on said edge are in the correct position to allow the subsequent clipping of the profile 3 on these auxiliary anchoring pieces 4 and achieving a correct positioning of said profile.

The positioning means mentioned consist of a partition 8 protruding from each auxiliary anchoring piece 4, starting from one of the laterals parallel to the surfaces of the door and in a direction perpendicular to the support surface 9 of said auxiliary pieces 4 on the edge 7 of the door.

In the example shown in the drawings, the partition 8 forms part of two arms 10 by way of which said partition is connected to the plate comprising the auxiliary anchoring piece 4.

With the configuration described, in order to ensure the position of the anchoring pieces 4 on the edge 7, it is sufficient to attach said pieces on the edge of the door, supporting the partition 8 on one of the surfaces of the door. In this position, the auxiliary pieces 4 are fixed to the edge of the door by means of screws 6 and then the arms 10 are cut, in order to eliminate the partition 8 and be able to thus couple the profile 3 on the auxiliary pieces 4.

In FIG. 3, an auxiliary piece 4 is shown with the partition 8 which serves as positioning means and a second piece 4′ in which the partition 8 and arms 10 have already been removed.

In order to facilitate the separation of the arms 10 and the partition 8, the auxiliary pieces 4 may have a line of weakness 11 coinciding with the plane of separation between the arms 10 and the plate 12 comprising the auxiliary pieces.

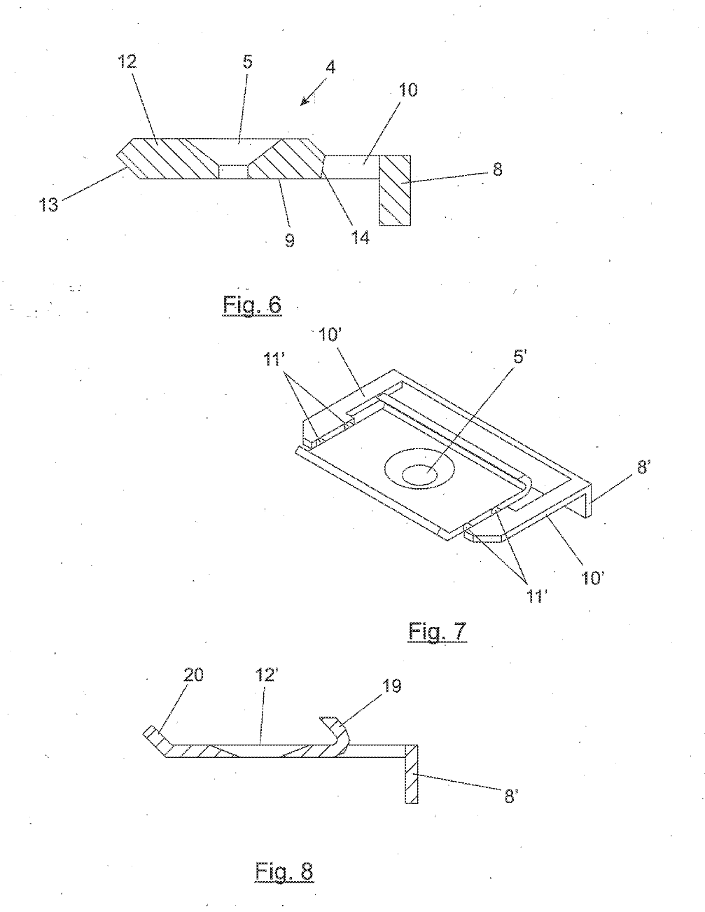

As may be seen in FIG. 6, the plate 12 has at least partly the edges 13 and 14 parallel to the surfaces of the door 2 inclined in opposite directions, such that they converge in a descending direction.

In turn, the profile 3 has, as may be seen in FIGS. 1 and 2, on the support surface on the edge 7 of the panel 2, a central longitudinal hollow 15 with width identical to that of the auxiliary anchoring pieces 4, this hollow 15 being limited longitudinally by edges 16 and 17 having inclines opposed to those of the edges 13 and 14 of the auxiliary pieces 4 and separated from each other at a distance equal to that of said edges.

With this configuration, the profile 3 may be mounted by clipping on the auxiliary pieces 4, for which the edge 16 of the profile 3 is supported on the edge 13 of the auxiliary piece 4 and the profile is then pressured and tilted in the direction of the arrow A of FIG. 2, until the edge 17 of the profile 3 is coupled on the edge 14 of the auxiliary piece 4 as shown in FIG. 1.

The profile 3 preferably has, starting from the rear longitudinal edge, a wing 18 perpendicular to the support surface of said profile on the edge of the door, the wing of which is attached on the rear surface of the panel 2 of the door to complete the clipping operation as shown in FIG. 1. This wing 18 may also be fixed to the panel 2 by means of an adhesive.

In FIGS. 7 and 8, a variant embodiment of the auxiliary anchoring piece is shown, comprising a plate 12′ which, as in the case of FIGS. 4 to 6, has a partition 8′ which serves as positioning means for the piece on the edge of the panel 2 of the door. This plate also has an opening 5′ for passing the anchoring and flap screw 19 and 20, which protrude in number and position coinciding with the edges 16 and 17 of the profile 3 and with inclines opposed to said edges, to define the clipping means of the profile 3.

As in the previous case, the partition 8′ is removed by means of cutting the arms 10′.

The auxiliary anchoring pieces, in any one of the embodiments, may be of plastic material or of metallic nature.

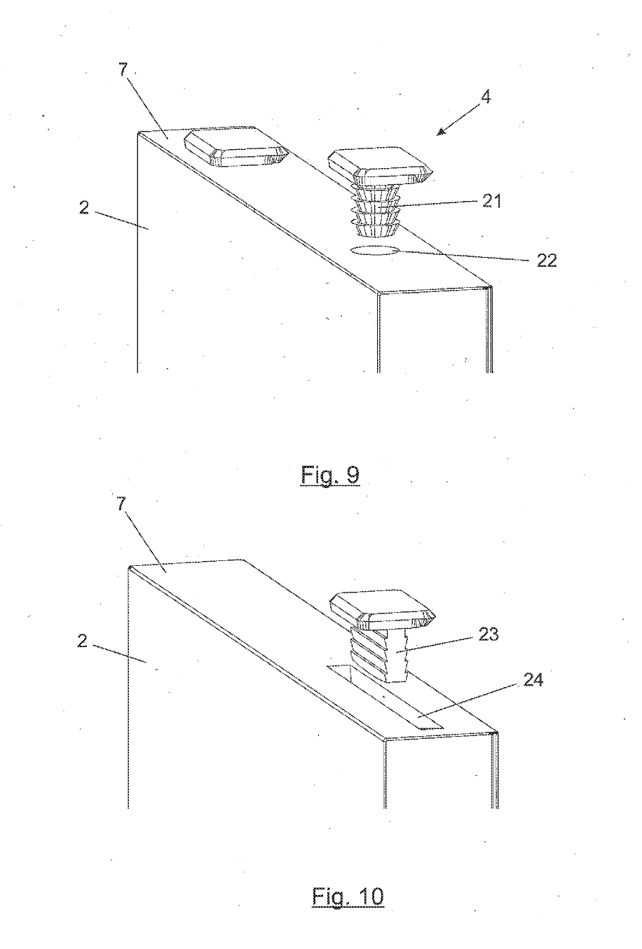

In the variant embodiment shown in FIG. 9, the plate comprising the auxiliary piece 4 lacks the opening 5 and the partition 8, which includes the auxiliary piece of FIGS. 4 to 6. In contrast, in the present case, the plate has, starting from its lower surface, a cylindrical barbed projection 21 intended to be introduced in a fitted manner into a mechanized housing 22 starting from the edge 7 of the door 2.

The barbed projection may adopt the form of partition 23, barbed horizontally on both surfaces, which is introduced into a groove 24 running along the edge 7 of the panel 2.

With this embodiment, the barbed projection and housing of the panel in which said projection is introduced, serve as fixing means of the auxiliary piece and positioning means of the same.

1. Furniture door with handle, comprised of a panel along one of the edges of which is mounted a profile comprising the handle, wherein the profile mentioned is fixed on the edge of the door by means of clipping of said profile on auxiliary anchoring pieces fixed to the edge of the door; the pieces of which consist of plates with width less than the edge of the door which have positioning and fixing means on said edge; and the profile of which and auxiliary pieces have opposing configurations coupleable by pressure which define the clipping means.

2. Door according to claim 1, wherein the positioning means of the auxiliary anchoring piece consist of a partition protruding from one of the laterals of the plate parallel to the surfaces of the door, in a direction perpendicular to the support surface of said plate on the edge of the door and is intended to be attached on one of said lateral surfaces of the door, and the means for fixing to the edge of the door comprise at least one opening which the plate has for passing fixing screws to said edge.

3. Door according to claim 1, wherein the configurations of the auxiliary anchoring pieces which define the anchoring means comprise two opposing edges parallel to the surfaces of the door, the edges of which have opposing inclines which converge towards the support base on the edge of the door; and in that the profile has, on its support surface on the edge of the door, a central longitudinal hollow with width coinciding with that of the auxiliary anchoring pieces, the hollow of which is longitudinally limited by edges which have inclines opposed to that of the opposing edges of said auxiliary pieces, with coinciding separation between one edge and the other.

4. Door according to claim 1, wherein the configurations of the auxiliary anchoring pieces which define the clipping means comprise flaps protruding in coinciding number and position from said piece and from the opposing surface of the profile, the flaps of which have opposing inclines and coinciding separation on the auxiliary anchoring pieces and profile.

5. Door according to claim 1, wherein the positioning and fixing means of the auxiliary piece consist of a barbed projection protruding from the lower surface of the plate which forms said auxiliary piece and in a mechanized housing, starting from the edge of the door, dimensioned for receiving said projection in a fitted manner.
